(19) United States
(12) Patent Application Publication
(10) Pub. No.: US 2012/0153600 A1
(43) Pub. Date: Jun. 21, 2012

(54) AIRBAG MODULE HAVING SURFACE STRUCTURE

(75) Inventor: Ulrich Rick, Braunweiler (DE)

(73) Assignee: GM GLOBAL TECHNOLOGY OPERATIONS, INC., Detroit, MI (US)

(21) Appl. No.: 12/680,464

(22) PCT Filed: Jul. 17, 2008
(86) PCT No.: PCT/EP08/05839

§ 371 Date: Mar. 8, 2012

(30) Foreign Application Priority Data
Sep. 27, 2007 (DE) 102007046211.7

(51) Int. Cl. B60R 21/16

(52) U.S. Cl. 280/728.2

(57) ABSTRACT

An airbag module is provided having an airbag, or gas generator for filling the airbag, and a housing for receiving the airbag in the unfilled state, which has a front side, in which an airbag exit opening is implemented, the front side having a surface structure which prevents a flat contact of the airbag exit opening on a plane.

### CROSS-REFERENCE TO RELATED APPLICATIONS

This application is a U.S. National-Stage entry under 35 U.S.C. §371 based on International Application No. PCT/EP2008/005839, filed Jul. 17, 2008, which was published under PCT Article 21(2) and which claims priority to German Application No. 102007046211.7, filed Sep. 27, 2007, which are all hereby incorporated in their entirety by reference.

### TECHNICAL FIELD

The present invention relates to an airbag module having an airbag, a gas generator for filling the airbag, and a housing for receiving the airbag in the unfilled state, in whose front side an airbag exit opening is implemented.

### BACKGROUND

The gas generator of an airbag module contains a typically pyrotechnic gas-generating propellant, for example, in the form of gas charge tablets, which, after triggering by an trigger device, such as an electrical spark generator, release a rapidly expanding gas, which fills the airbag and unfolds it in this way, so that it exits with high momentum from the airbag exit opening.

Triggering of the gas generator and thus unfolding of the airbag can occur unintentionally or intentionally, for example, for test purposes, due to the heating of the airbag module and thus the propellant contained in the gas generator in particular. For example, an airbag module is intentionally subjected to a fire having a specific flame temperature for a predetermined period of time during the so-called bonfire test.

If the airbag module has a front side, in which the airbag exit opening is implemented, resting flatly on a plane, such as a storage shelf or a test surface during the bonfire test, a high pressure initially arises in the interior of the housing due to the generated gas and the unfolding airbag. Because of the mass inertia of the housing lying over the airbag exit opening, this pressure cannot dissipate with unfolding of the airbag through the airbag exit opening—which is initially closed by the flat contact on the plane—so that fragmentation of the housing can occur. The fragments of the housing thus resulting, in particular the gas generator, are highly accelerated in this case and represent a hazard to the surroundings. This can particularly result in the non-approval of the airbag module because of explosives laws or the like.

Such fragmentation can occur in particular if, upon storage of the airbag module on its front side, the gas generator, which typically has a higher weight, is situated above the airbag exit opening and makes it more difficult for the airbag module to lift off of the plane, which would allow unfolding of the airbag and thus dissipation of the pressure.

DE 20 2004 014 775 U1 therefore proposes a so-called early trigger apparatus, which causes controlled burn-off of the pyrotechnic propellant before a corresponding violent gas generation can result in fragmentation of the housing. In the event of suddenly occurring very high flame temperatures, rapid gas development and pressure generation in the housing interior with the disadvantages described above can nonetheless occur. In addition, the multistage construction of the triggering apparatus is complex.

At least one object of the present invention is therefore to reduce the danger of fragmentation of an airbag module stored on a front side. In addition, other objects, desirable features, and characteristics will become apparent from the subsequent summary and detailed description, and the appended claims, taken in conjunction with the accompanying drawings and this background.

### SUMMARY

An airbag module according to an embodiment of the present invention comprises an airbag and a gas generator for filling the airbag. The gas generator can particularly comprise a pyrotechnic gas-generating propellant, which can be electrically triggered, for example, and generates a rapidly expanding gas after triggering, which fills the airbag and unfolds it. In the unfilled state, the airbag is received in the housing, preferably folded. The gas generator can be entirely or partially received in the housing or fastened thereon. The housing is produced from plastic and/or metal in a preferred embodiment.

It has a front side, in which an airbag exit opening is implemented. This opening can be essentially rectangular or oval or have another contour, for example.

According to an embodiment of the invention, the front side of the housing, in which the airbag exit opening is implemented, has a surface structure, which prevents a flat contact of the airbag exit opening on a plane. This prevents the airbag from initially not unfolding through an airbag exit opening, which rests flatly on a plane and is thus essentially hermetically closed, and it is thus possible dissipate the pressure generated by the triggered gas generator. This reduces the danger that the airbag module will be fragmented as a result of self-triggering or external triggering of the gas generator, if it is stored having its front side on a plane.

In the event of non-flat contact of the airbag exit opening, one or more intermediate spaces or gaps, through which the airbag can unfold, result between the front side and a plane on which it is stored. In this way, not only can pressure in the housing interior be dissipated. In addition, the airbag expanding between the front side and plane in the gap or gaps can tilt the airbag module out of its location, so that the airbag exit opening tilting away from the plane is no longer closed thereby and the airbag can unfold more freely. More rapid pressure dissipation in the housing interior thus occurs, so that the danger of fragmentation of the housing is reduced.

In order to reinforce this effect, the surface structure can be implemented so that tilt-stable storage of the airbag module having its front side on the plane is prevented or made more difficult. Tilt-stable storage is to be understood as storage which opposes tilting from its location on a horizontal plane with a great resistance. For example, while a cube resting on its front side on a horizontal plane, in which its weight force is oriented vertically through the surface center of gravity of the front side, opposes tilting around an edge of the front side with a relatively high resistance torque, i.e., is stored so it is tilt-stable, an airbag module having a rounded front side, which has a surface structure in the form of a spherical, cylindrical, or conical part, can be tilted more easily, for example. Because a front side having such a surface structure additionally does not rest flatly on a plane and thus does not hermetically close the airbag exit opening, the unfolding airbag can exit through the gaps between such a front side and the plane and tilt the housing. A non-tilt-stable storage in the meaning of the present invention results in particular if, upon storage of the airbag module having its front side on a horizontal plane, the weight force engaging in the center of gravity of the airbag module does not run through the area center point of the front side projected onto the horizontal plane.

The surface structure has a contact plane, i.e., the plane of all points of the front side which touch this plane upon its contact on a plane. This contact plane is preferably inclined by an angle to the plane in which the airbag exit opening lies. This angle can preferably be between approximately 5° and approximately 45°. If such an airbag module is laid on a horizontal plane, it is inclined relative thereto by this angle, so that an impulse of the airbag unfolding through the airbag exit opening is not incident vertically on the horizontal plane, but rather inclined, whereby the airbag module is tilted.

In a preferred embodiment of the present invention, one or more projections are implemented on the front side of the housing. These projections may be implemented in the form of pins, bows, or fans, for example. They may also extend in the form of ribs over a part or the entire length of the front side. Likewise, projections may also be implemented having a broad surface. All projections may have the same shape. Likewise, however, it is also possible to combine projections of different shapes with one another.

It is easily possible to provide gaps between the front side and a plane on which the airbag module is stored through such projections, without impairing the design freedom in the implementation of the housing. In particular, tilt-stable storage can be prevented by such projections.

One or more, in particular all projections may be removably fastened on the housing, for example, screwed or locked thereon. It is thus possible to store and/or test the airbag module having fastened projections and thus prevent the danger of fragmentation of the housing upon triggering of the gas generator. The projections may then be detached shortly before the installation in a motor vehicle, so that a flat contact of the front side on the rear of a dashboard or the like may again be implemented, for example.

Likewise, one or more projections may also be permanently fastened on the housing, for example, glued or welded thereon. When the housing is originally formed, for example, injection molded or cast, the projections may advantageously be implemented integrally with the housing. This reduces the production effort and ensures that the front side of the housing cannot unintentionally be stored flatly on a plane.

In particular if the projections do not exert a supporting function, but rather only prevent a flat contact of the front side on a plane, openings may be provided in the projections in a preferred embodiment, in order to reduce their weight and save material.

If the projections remain on the housing even upon installation in the motor vehicle, they preferably have a contour which allows the projections to be received in corresponding recesses in the motor vehicle. If an airbag module according to the invention is a driver airbag module, for example, the projections may be implemented so that they are received in recesses in a steering wheel pot or a steering wheel cover, when the airbag module is mounted in a steering wheel. If the airbag module according to the invention is a passenger airbag module, the projections may correspond to recesses which are implemented on a rear side of a dashboard facing away from the passenger compartment. If the airbag module according to the invention is a side airbag module, the projections may be received in recesses which are implemented in a door panel, a panel of an A, B, or C column, or a roof lining. A particularly space-saving installation of the airbag module thus results in each case. In addition, the projections may be used as an installation aid and fix the airbag module in its installation location.

The projections may preferably also be used as guide wings for the unfolding airbag. The airbag unfolds through the airbag exit opening in a way predetermined by its section, the gas entry, and the like. If projections are situated on the front side in which the airbag exit opening is implemented, with which the unfolding airbag comes into contact, the unfolding characteristic of the airbag can also be controlled by intentional placement and implementation of the projections. For example, by one projection, shadowing of an area lying behind this projection in relation to the unfolding airbag can be defined.

The airbag exit opening can preferably be closed by a panel which is opened by the unfolding airbag. This panel can have intended breakpoints, for example, which are implemented by perforation or material weakening and are destructively opened. The panel can also have one or more flaps which are pushed open by the unfolding airbag.

As previously described, the hazard of a heavy gas generator situated on a rear side of the housing opposite to the front side increases the hazard that an airbag module resting flatly on a plane will fragment under the effect of heat, because the pressure generated by the triggered propellant in the hermetically closed housing interior increases too rapidly as a result of the mass inertia, which counteracts lifting of the housing off of the plane and thus exposure of the airbag exit opening. In an airbag module according to an embodiment of the invention, in contrast, the gas generator can be situated on the side of the housing opposite to the front side, which increases the design freedom of the airbag module. The gas generator is advantageously situated off-center in relation to the airbag exit opening and/or the front side, so that a non-tilt-stable storage results because of the weight distribution.

### BRIEF DESCRIPTION OF THE DRAWINGS

The present invention will hereinafter be described in conjunction with the following drawing figures, wherein like numerals denote like elements, and:

FIG. 1 shows an airbag module according to a first embodiment of the present invention in a side view;

FIG. 2 shows an airbag module according to a second embodiment of the present invention in a side view;

FIG. 3 shows an airbag module according to a third embodiment of the present invention in a side view; and

FIG. 4 shows an airbag module according to a fourth embodiment of the present invention in a side view.

### DETAILED DESCRIPTION

The following detailed description is merely exemplary in nature and is not intended to limit application and uses. Furthermore, there is no intention to be bound by any theory presented in the preceding background or summary or the following detailed description.

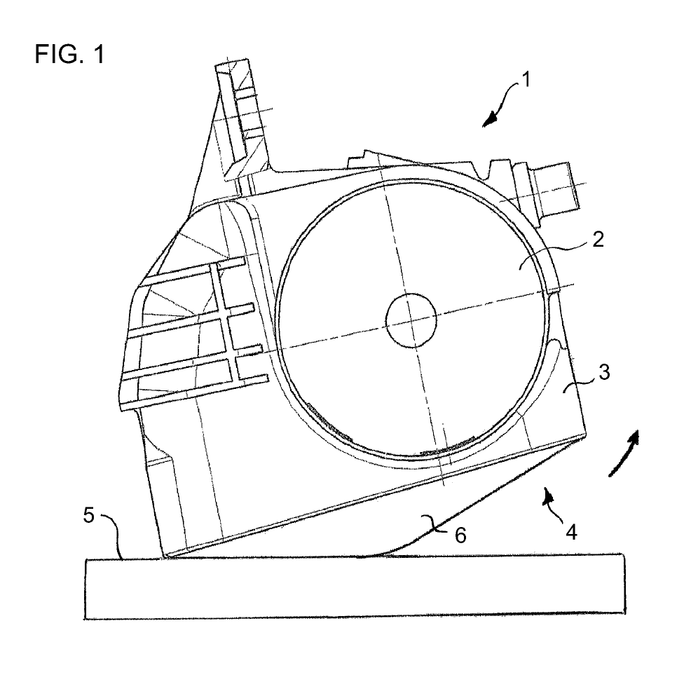

FIG. 1 shows an airbag module 1 according to a first embodiment of the present invention. It comprises a housing 3, which is produced as a plastic originally molded part, and a gas generator 2, which is received in the housing 3, for filling an airbag (not shown), which is also received in the housing 3 and is folded up in the starting state.

On a front side 4, the housing has an essentially rectangular airbag exit opening (not shown), which is closed by a thin diaphragm (not shown). Upon triggering of the gas generator 2, which contains gas charge tablets (not shown), it fills the airbag with a rapidly expanding gas, so that the originally folded airbag unfolds, exits through the airbag exit opening, and tears open the diaphragm along intended breakpoints predetermined by material weakening.

On its front side 4, the housing 3 has two ribbed projections 6 situated laterally adjacent to the airbag exit opening, which essentially have the contour of a flat, rounded triangle in the side view, whose footprint extends over the entire front side 4, and of which only one is visible in FIG. 1.

If the airbag module 1 according to the first embodiment of the present invention, as shown in FIG. 1, is stored having its front side 4 on a horizontal plane 5, such as a storage shelf or a test surface for a bonfire test, the projections 6 result in tilting of the airbag module, so that a triangular gap arises between the front side 4 and the horizontal plane 5 on one side (on the right in FIG. 1). A non-tilt-stable storage of the airbag module 1 on the horizontal plane 5 thus results, because the airbag module 1 is already slightly tilted in relation to the horizontal plane 5 and thus further tilting is only opposed by a comparatively slight resistance.

If the airbag module 1 according to the first embodiment of the present invention is subjected to a fire in the position shown in FIG. 1 unintentionally, for example, during storage, or intentionally, for example, in the context of a bonfire test, the gas charge tablets of the gas generator 2 ignite and fill the airbag. The airbag exits through the airbag exit opening, which is not closed by the horizontal plane 5 in the area of the triangular gap (on the right in FIG. 1), and unfolds into this gap. A part of the pressure generated by the gas generator 2 is thus already dissipated.

The airbag module 1 is tilted further in the direction indicated by an arrow in FIG. 1 by the airbag unfolding in the gap between front side 4 and plane 5, so that the airbag exit opening in the front side 4 reaches a free position essentially perpendicular to the plane 5, through which the airbag can unfold further essentially unobstructed.

Through the firing direction of the airbag module 1, which is inclined because of the triangular projection 6 in relation to the horizontal plane 5, the unfolding airbag hits the plane 5 at an inclined angle and thus advantageously reinforces the tilting movement.

All of this reduces the danger that an airbag module 1 stored on its front side 4 will be fragmented as a result of a triggering of its gas generator 2.

If the unfolding airbag exits from the airbag exit opening, it touches the two lateral projections 6 from the inside. These projections thus shadow areas facing away from the airbag exit opening laterally adjacent to the projections in relation to the unfolding airbag and thus act as guide wings, which also predetermine the unfolding characteristic of the airbag.

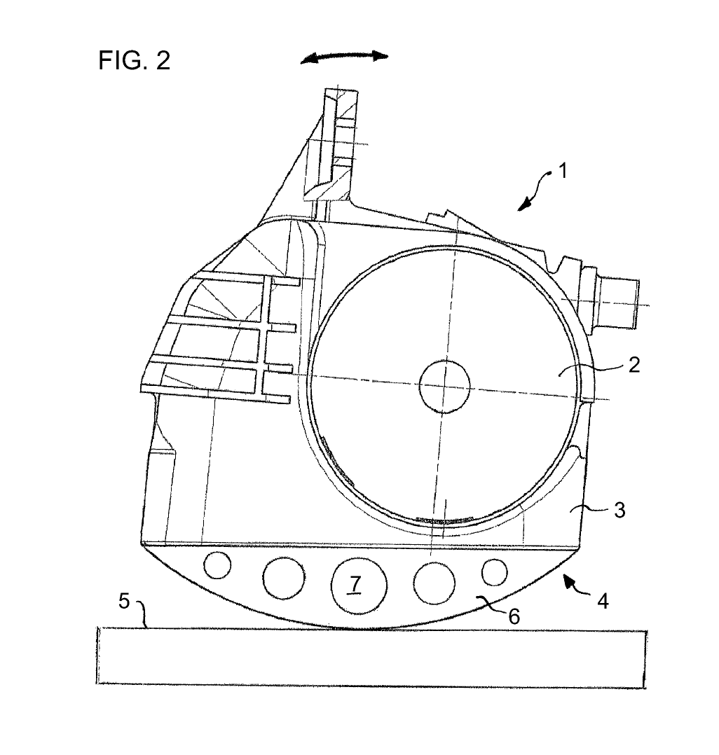

FIG. 2 shows an illustration corresponding to FIG. 1 of an airbag module 1 according to a second embodiment of the present invention. Identical elements are provided with identical reference numerals, so that their description will be dispensed with and only the differences from the first embodiment are discussed hereafter.

The two laterally situated and ribbed projections 6 are implemented essentially in the form of circular segments in the second embodiment. Gaps thus result on both sides (on the left and right in FIG. 2) between the front side 4 and the horizontal plane 5, through which the airbag unfolds and can tilt the airbag module in a direction indicated by the double arrow. Because of the rounded contour of the front side 4, the airbag module 1 can be tilted easily, i.e., it is not stored tilt-stable. Whether the airbag module 1 according to the second embodiment of the present invention tilts clockwise or counterclockwise is a function, for example, of the firing direction of the airbag, the weight distribution of the airbag module 1, and the like.

The two lateral projections 6 in the form of circular segments have openings 7 in the second embodiment, to save material and weight.

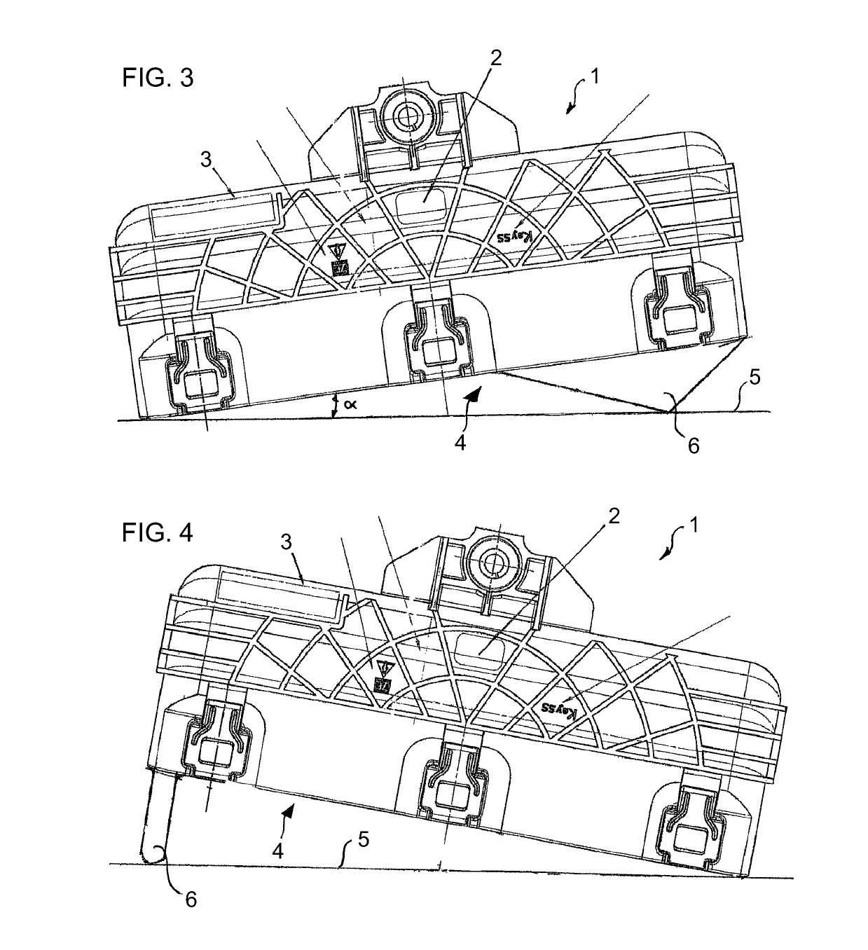

FIG. 3 shows an illustration corresponding to FIG. 1 and FIG. 2 of an airbag module 1 according to a third embodiment of the present invention. Identical elements are again provided with identical reference numerals, so that their description will be dispensed with and only the differences from the first and second embodiments are discussed hereafter.

In the airbag module according to the third embodiment of the present invention, the lateral ribbed projections 6, which are triangular in the side view, do not extend over the entire front side 4, but rather are only implemented on one side (on the right in FIG. 3). If the airbag module 1 according to the third embodiment has its front side 4 resting on the horizontal plane 5, only the edge of the front side area in which no projections are implemented (on the left in FIG. 3) and the tips of the pyramidal projections 6 touch the horizontal plane 5. The contact plane of the surface structure of the airbag module 1 defined by this edge and these tips has an angle α of approximately 5° in relation to the plane in which the airbag exit opening lies, so that the airbag module 1 has a firing direction inclined against the gravitation direction or the horizontal plane 5 in relation to the horizontal plane 5 upon storage on its front side 4. If the gas generator is triggered, the unfolding airbag protrudes and exits between the laterally situated projections 6 and tilts the airbag module 1 in the mathematically positive direction.

FIG. 4 shows an illustration corresponding to FIG. 1-FIG. 3 of an airbag module 1 according to a fourth embodiment of the present invention. Identical elements are again provided with identical reference numerals, so that their description will be dispensed with and only the differences from the first through third embodiments are discussed hereafter.

In the fourth embodiment, the flat contact of the airbag exit opening on the plane 5 is prevented by pin-shaped projections 6 plugged on to one side of the front side 4 (on the left in FIG. 4). During the storage or also during a bonfire test, the airbag, which unfolds as a result of a triggering of the gas generator 2, tilts the airbag module 1 stored on its front side 4 on the horizontal plane 5 clockwise and can thus unfold rapidly outside the housing 3. The danger of fragmentation of the housing 3 is thus reduced.

For installation on a flat rear side of a dashboard (not shown), the plugged-on projections 6 are removed and the airbag module 1 is fastened to the dashboard in a known way, for example, screwed on. The danger of fragmentation of the housing 3 is already reduced in this installed state in that upon triggering of the gas generator 2, the unfolding airbag can exit through the airbag exit opening and a corresponding opening in the dashboard.

In particular in the first, third, and fourth embodiments, because of the surface structure of the front side 4 implemented having projections 6, a non-tilt-stable storage results, because in the storage of the airbag module 1 in FIG. 1, FIG. 3, and FIG. 4 having its front side 4 on the horizontal plane 5, the weight force engaging in the center of gravity of the airbag module does not run through the area center point of the front side projected on the horizontal plane.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. An airbag module, comprising:
a gas generator adapted to fill the airbag; and
a housing adapted to receive the airbag in an unfilled state, which has a front side in which an airbag exit opening is implemented;
wherein the front side has a surface structure that prevents a flat contact of the airbag exit opening on a plane.

2. The airbag module according to claim 1, wherein the front side has the surface structure that prevents a tilt-stable storage of the airbag module having its front side on the plane.

3. The airbag module according to claim 2, wherein the front side has the surface structure in a form of a spherical part.

4. The airbag module according to claim 3, wherein the surface structure has a contact plane that forms an angle (α) greater than approximately 0°.

5. The airbag module according to claim 1, wherein the surface structure is implemented so that at least one gap results between the front side and the plane when the front side of the airbag module is in contact with the plane.

6. The airbag module according to claim 1, wherein at least one projection is implemented on the front side.

7. The airbag module according to claim 6, wherein the at least one projection is implemented in a form of a pin.

8. The airbag module according to claim 6, wherein the at least one projection is removably fastened on the housing.

9. The airbag module according to claim 6, wherein the at least one projection is permanently fastened on the housing.

10. The airbag module according to claim 6, wherein the at least one projection comprises at least one opening.

11. The airbag module according to claim 6, wherein the at least one projection comprises a contour to be received in a recess that is implemented in a passenger compartment element.

12. The airbag module according to claim 6, wherein the at least one projection is implemented as a guide wing.

13. The airbag module according to claim 1, wherein the airbag exit opening comprises a panel that can be opened by the airbag.

14. The airbag module according to claim 1, wherein the gas generator is situated on an opposite side of the housing that is opposite to the front side.

15. (canceled)

16. The airbag module according to claim 2, wherein the front side has the surface structure in a form of a cylindrical part.

17. The airbag module according to claim 2, wherein the front side has the surface structure in a form of a conical part.

18. The airbag module according to claim 3, wherein the surface structure has a contact plane that forms an angle (α) greater than between approximately 5° and approximately 45° with the plane in which the airbag exit opening lies.
